(19) United States
(12) Patent Application Publication
(10) Pub. No.: US 2012/0138082 A1
(43) Pub. Date: Jun. 7, 2012

(54) Self contained oral hygiene unit

(76) Inventors: Joshua Pardue, Los Angeles, CA (US); Branden Kakugawa, Laupahoehoe, HI (US)

(21) Appl. No.: 12/928,156

(22) Filed: Dec. 6, 2010

(51) Int. Cl. A46B 15/00; A61C 15/04

(52) U.S. Cl. 132/309

(57) ABSTRACT

The Dental Hygiene Unit Borrows Its Shape From The Modern Toothbrush, But Is Distinguishable By the Modular Bristle Head And The Self-Contained Dental Floss Dispenser. The Uniqueness Being The Convenient Proximity Of Dental Hygiene Supplies In A Single Source.

### BACKGROUND OF INVENTION

One Day Me & Branden Were Hanging Out Watching T.V. & A Commercial About A Small Portable Toothbrush Came On & Right After That A Commercial Of Dental Floss Came On Next. Then I Said To Joshua I Wish They Were Together So I Don't Forget To Floss All The Time, And He Said You're A Genius Lets Invent That Idea Cause Joshua You Are An Inspiring Inventor. Thus We Came Up With The Idea to Have A Concept Toothbrush That Dispenses Dental Floss & Have A Replaceable Head, So That The Consumers Would Never Have To Buy A Plain Simple Toothbrush Again, And With These Easy To Use Convenience When Traveling.

### BRIEF SUMMARY OF INVENTION

This Invention Is Self-Contained Oral Hygiene Unit. Its Features Are A Modular Bristle Head And Dental Floss Cartridge. It Addressed The Convenience Of Having The Necessary Oral Hygiene Item For Teeth Maintenance In A Singular Proximity With Each Other, While Catering To The Preference Of The Consumers. The Bristle Head Can Be Easily Changed Or Interchanged With Any Easy Style Of Firmness Or Shape. The Dental Floss Can Likewise Be Interchanged With Any Preference Of Flavor, Thickness, Or Waxing. Thought In General Shape Of A “Toothbrush” Its Features Are Broader And Addresses More Than A Singular Surface Cleaning Instrument.

### BRIEF DESCRIPTION OF SEVERAL VIEWS OF DRAWING

FIG. 1.

Depicts The Dental Hygiene Unit From A Side View Which Displays Its Lock While Ready For Brushing Use. Bristles Are In Place, Dental Floss Dispenser Cap Is Sealed And Has Sealed The Bobbin Into The Handle Cavity Of The Dental Hygiene Unit. Cap Hinge Is Displayed On Top And The Flip Fingernail Catch Is Displayed On The Bottom. The Diagonal Lines Indicate The Thumb Grip Built In To The Handle For Brushing Use.

FIG. 2.

Depicts The Same View As FIG. 1. With Transparent Added To Show The Modular Bristle Head And The Woven Bobbin Cartridge Secured Within The Handle.

FIG. 3.

Is The Top View Displaying The Thumb Grip And The Bristle Head Displays, Bristles, Ventilation And The Thumb Release For Dislodging The Modular Head.

FIG. 4.

Depicts The Bottom View Displaying The Ventilation Holes On The Bottom Of The Modular Receptacle.

FIG. 5.

Depicts The Modular Receptacle Without The Ventilation. Holes. The Receptacle For The Thumb Release And The Ball Joints That Provide The Locking Tension To Keep The Modular Bristle Head In Place.

FIG. 6.

Depicts The Functionality Of The Modular Bristle Head And The Receptacle. Shown Is The Modular Bristle Head Half Dislodge Revealing The Form Fitted Design And Ventilation System.

FIG. 6(A).

Depicts The Top View Of The Modular Bristle Head.

FIG. 6(B).

Depicts The Bottom View Of The Modular Bristle Head.

FIG. 6(C).

Depicts The Side View.

FIG. 6(D).

Depicts The Front. View.

FIG. 6(E).

Depicts The Back View.

FIG. 7.

Depicts The Dental Floss Bobbin Half Inserted Into The Dental Hygiene Unit Handle Cavity. The Locking Device Is Displayed At The End Of That. Shaft To Insert Into The. Matching Slot At The Bottom Of The Cavity. The Bobbin Shaft Has Hilt. Spacers Top And Bottom To Help It Conform To The Cavity Dimensions.

FIG. 8.

Depicts The Bobbin Shaft Empty Of Dental Floss.

FIG. 9.

Depicts The Bobbin Shaft Full Of Dental Floss.

FIG. 10.

Depicts The Various Views Of The Dental Floss Dispenser.

FIG. 10(A).

Shows The Cap Sealed.

FIG. 10(B).

Is A Transparent Top View Of The Cap Showing The. Twist Lock Feature Accomplished By The Twisting Of The Bobbin Shaft Sealed Underneath The Cap.

FIG. 10(C).

Depicts A Transparent Side View Of. The Cap Revealing The Flip Top, Hinge, Thread Hole, And Tension Cutter And Grip Clip.

FIG. 10(D).

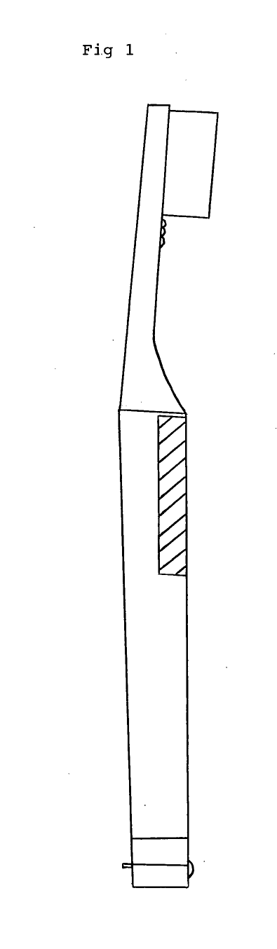

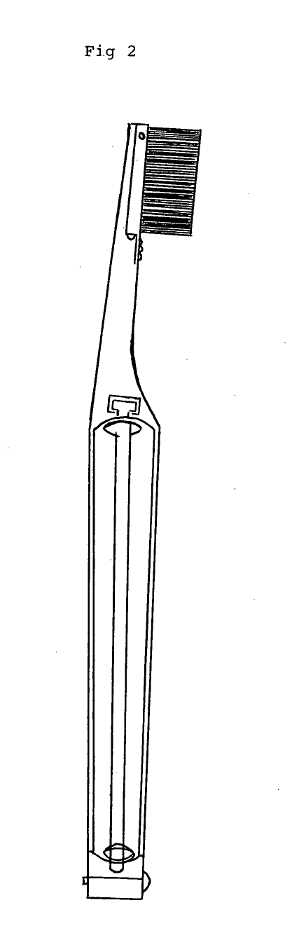

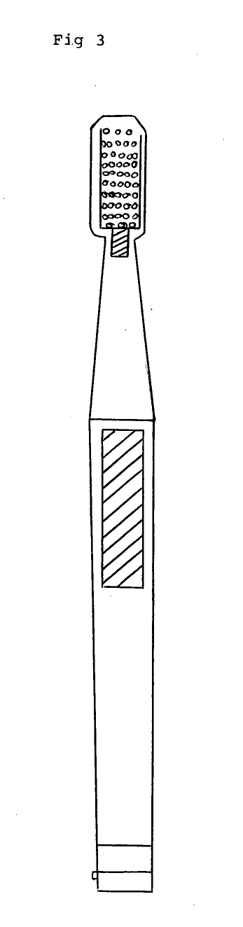

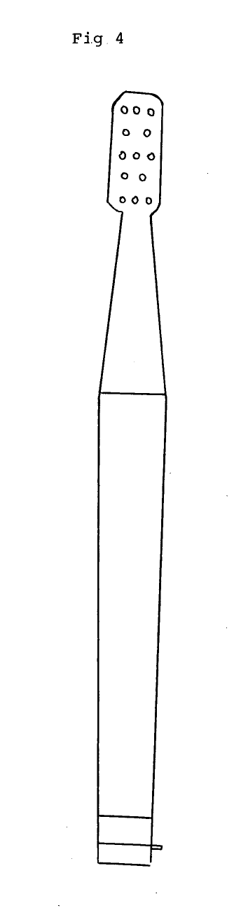

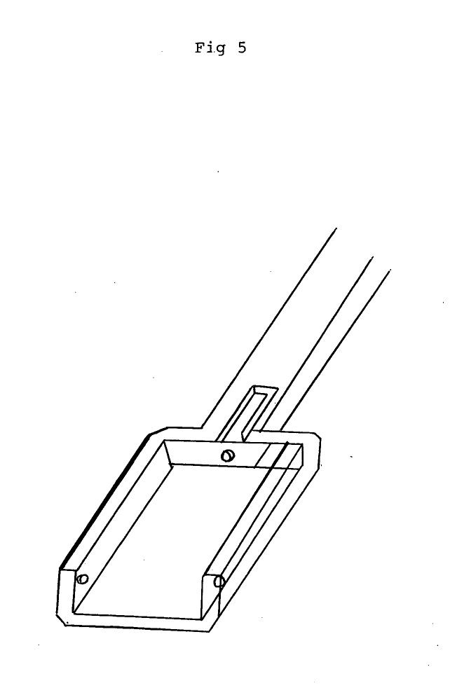

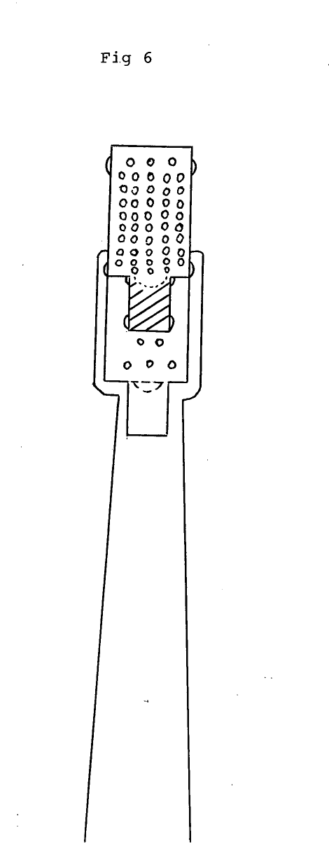

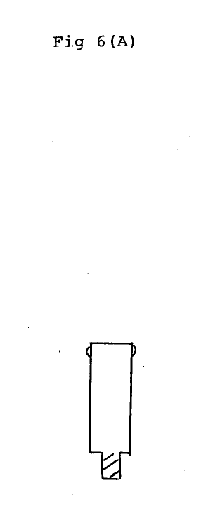

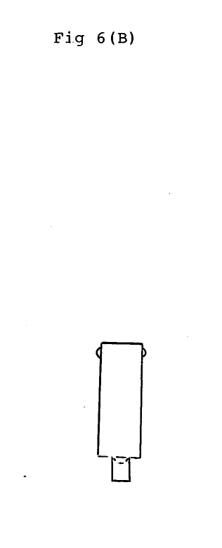

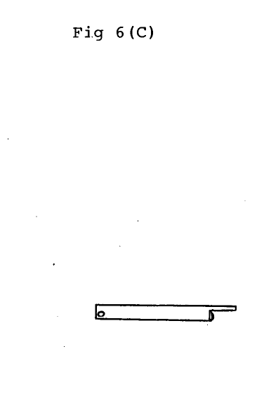

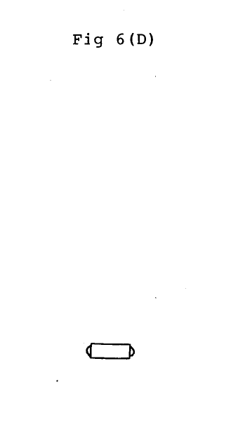

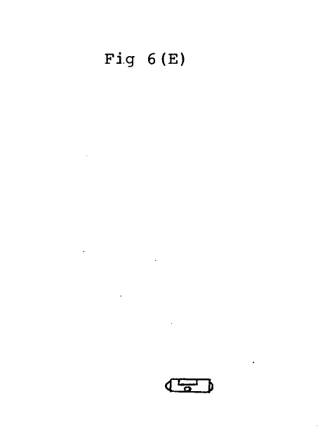

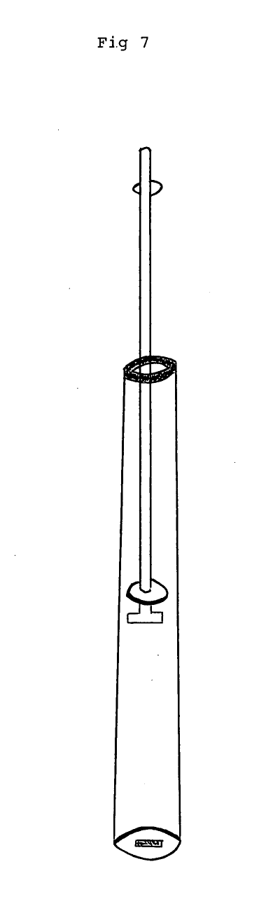

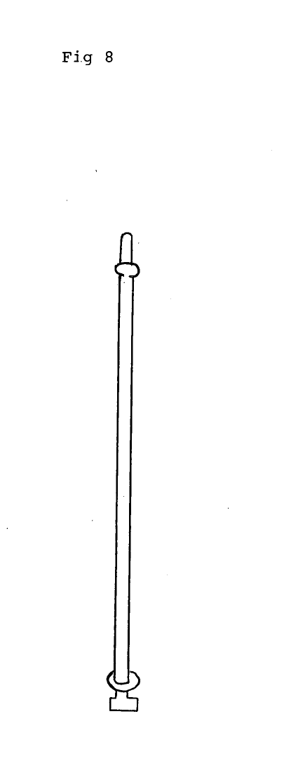

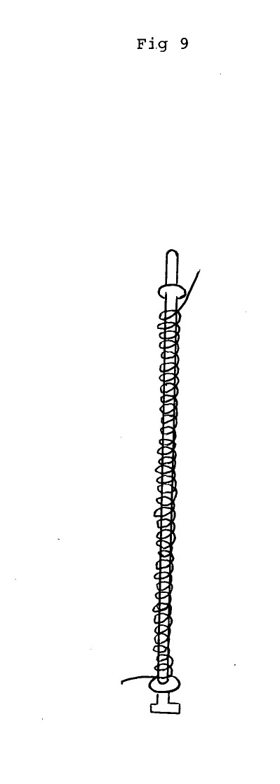

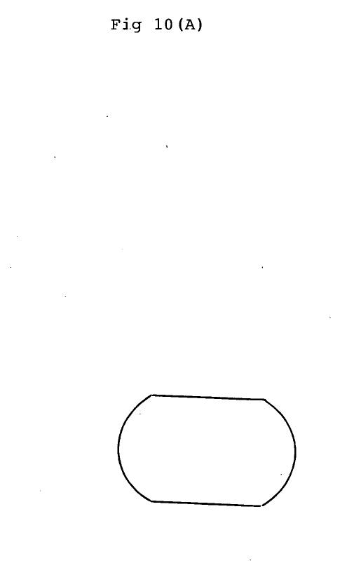

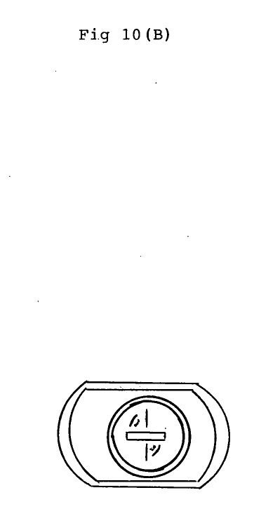

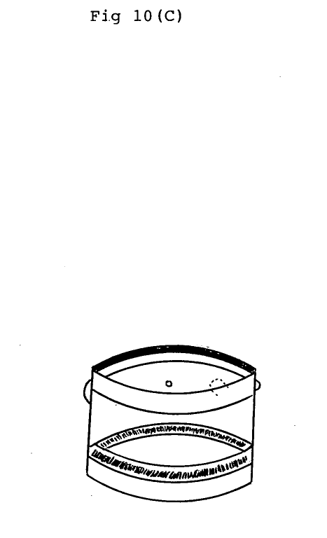

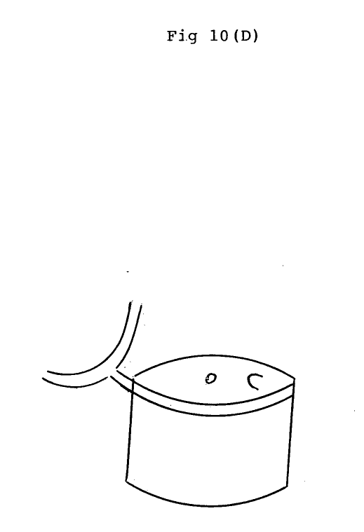

Shows The Cap Hinged Away From The Dental Floss Dispenser Surface Containing The Thread Hole And Tension Cutter And. Grip Clip.

### DETAILED DESCRIPTION

The Self-Contained Dental Hygiene Unit Borrows Its Shape And Size From The Traditional Toothbrush. Its Distinguishing Features Are:

The Modular Bristle Head—The Bristle Head Again Borrows Its Shape And Size From The Traditional Toothbrush. It Is Mounted Into The Dental Hygiene Unit By Form Fitting Shape And Ball Joints. The Surface Tension Being Sufficient Enough To Overcome Any Surface Torque Created During Brushing, Keeping It Lodged Within The Unit And Requiring An Intentional Effort To Dislodge. The Bristles Themselves Are Mounted Upon A Ventilated Cartridge Bed Allowing For Product Cleanliness And Efficiency Of Flowing For Toothpaste And Fluids During Brushing. The Bristles Are Not Fixed In Shape, Length, Or Firmness And Can Be Adjusted To Any Market Preference (Absent Any Infringements). The Uniqueness Of The Bristle Head Is That It Is Modular And Attaches To The Convenient Dental Hygiene Unit.

1. The Invention Makes The Claims Of A Convenient Self-Contained Oral Hygiene Unit. The Modular Bristle Head, The Dental Floss Cartridge, The Easy Dispenser Cap, And The Proximity Convenience Found In The Toothbrush Shape.
Dental Hygiene Unit Central To The Invention Is The Toothbrush Shaped Dental Hygiene Unit. Its Length Is Consistent With The Standard Of The Industry Within +Or −15%. The. Unit Consists Of An Indented Formed Receptacle For The Modular Bristle Head Mounted Upon A Shaft That. Leads To The Handle. The Handle Doubles As A Cavity To Receive The Dental Floss Dispenser Bobbin. At The Bottom The Cavity Is A Modular Twist Lock That Receives The Bobbin Shaft. This Allows The Bobbin Cartridge To Lock Firmly Into Position Which Allows The Bobbin To Unravel. The Cavity Is Capped Off With A Self Sealing Lip. Attached By Hinge. Underneath Of Which There Is An Easy Dispenser Cap. The Dispenser Is Typical In Style To The Market Standard In Functionally In That It Has A Thread Hole To Access The Bobbin And A Raised Clip To Act As A Tension Cutter And Grip.
Dental Floss Bobbin Cartridge The Dental Floss Is A Woven Bobbin Around The Shaft. The Shaft Has A Twist Lock Design That Spins Into The Lock Position At The Bottom Of The Cavity By The Twisting Between The Fingers Of The Consumer Of The Protruding Knob. The Knob Bottom Is Flush With The Cavity's Outer Lip And Entrance But The Protrusion Is Concealed Only When The Cap Dispenser Is. Sealed Upon The Cavity Entrance. The Seal Being A Snap-On By Contoured Lip And Tension Grip. When The Cap Dispenser Is Removed The Protruding Knob Extends Beyond The Cavity's Length For Easy Grip By The Consumer For Easy Twisting To Lock And Unlock Inserting Or Extracting The Dental Floss Bobbin. Once Sealed Within The Dental Hygiene Unit, The Floss Bobbin Unravels By The Consumer's Demand With A Simple Pull Through The Thread Hole.
